(19) United States
(12) Patent Application Publication
(10) Pub. No.: US 2022/0169837 A1
(43) Pub. Date: Jun. 2, 2022

(54) RUBBER COMPOSITION AND PNEUMATIC TIRE USING THE SAME

(71) Applicant: TOYO TIRE CORPORATION, Itami-shi (JP)

(72) Inventor: Takuya Kimura, Itami-shi (JP)

(73) Assignee: TOYO TIRE CORPORATION, Itami-shi (JP)

(21) Appl. No.: 17/519,032

(22) Filed: Nov. 4, 2021

(30) Foreign Application Priority Data
Dec. 1, 2020 (JP) 2020-199752

(51) Int. Cl. C08L 9/06; B60C 1/00; B60C 11/00

(52) U.S. Cl. CPC C08L 9/06; B60C 1/0016; B60C 2011/0025; C08L 2205/02; B60C 11/0008

(57) ABSTRACT

Provided is a rubber composition, from which a pneumatic tire with an excellent balance between rolling resistance performance (fuel efficiency) and wet grip performance can be obtained. The rubber composition contains, per 100 parts by mass of a diene-based rubber, 1 to 100 parts by mass of microparticles formed of a polymer having a glass transition point of −70° C. to 0° C., and the polymer includes a random copolymer composed of three or more kinds of structural units including at least a structural unit A, a structural unit B, and a structural unit C. The structural unit A is derived from an alkyl methacrylate whose homopolymerized polymer has a glass transition point of −50° C. to 0° C., the structural unit B is derived from an alkyl acrylate whose homopolymerized polymer has a glass transition point of −70° C. to −50° C., and the structural unit C is derived from a polyfunctional vinyl monomer.

### BACKGROUND OF THE INVENTION

### Field of the Invention

The present invention relates to a rubber composition and also to a pneumatic tire using the same.

### Description of the Related Art

For rubber compositions used for tires, a high-level balance between grip performance (wet grip performance) on a wet road surface and rolling resistance performance that contributes to fuel efficiency is required. However, because these characteristics are contradictory, it is not easy to improve them at the same time.

In order to deal with such a problem, JP-A-2017-110069 describes a rubber composition that achieves improved wet grip performance while suppressing a decrease in hardness at ambient temperature as well as an increase in elastic modulus and deterioration of rolling resistance performance at low temperatures. The rubber composition contains, per 100 parts by mass of a rubber component composed of a diene-based rubber, 1 to 100 parts by mass of microparticles formed of a (meth)acrylate-based polymer that has a predetermined alkyl (meth)acrylate unit as a constituent unit and has no reactive silyl group. The microparticles have a glass transition point of −70 to 0° C. and an average particle size of 10 nm or more and less than 100 nm.

In addition, JP-A-2020-84145 describes a rubber composition with an excellent balance between rolling resistance performance and wet grip performance. The rubber composition contains 1 to 100 parts by mass of microparticles having a glass transition point of −70 to 0° C. per 100 parts by mass of a diene-based rubber, wherein the microparticles are formed of a polymer having a crosslinked structure crosslinked by at least one kind of polyfunctional vinyl monomer, the crosslinked structure being configured such that functional groups of the polyfunctional vinyl monomer are connected by an optionally substituted divalent to tetravalent aliphatic hydrocarbon group, and the linear moiety connecting two such functional groups has 7 to 20 carbon atoms.

### SUMMARY OF THE INVENTION

However, the microparticles blended in the rubber compositions described in JP-A-2017-110069 and JP-A-2020-84145 have not been sufficiently examined for their constituent components or structures, and there has been room for improvement in rolling resistance performance (fuel efficiency) and wet grip performance.

In view of the above points, it is desirable to provide a rubber composition, from which a pneumatic tire with an excellent balance between rolling resistance performance (fuel efficiency) and wet grip performance can be obtained.

Incidentally, WO 2015/155965 describes a rubber composition containing, per 100 parts by mass of a rubber component composed of a diene-based rubber, 1 to 100 parts by mass of a (meth)acrylate-based polymer having a weight average molecular weight of 5,000 to 1,000,000 and a glass transition point of is −70 to 0° C. However, no particulate polymer is blended.

A rubber composition according to an aspect of the invention contains, per 100 parts by mass of a diene-based rubber, 1 to 100 parts by mass of microparticles formed of a polymer having a glass transition point of −70° C. to 0° C., and the polymer includes a random copolymer composed of three or more kinds of structural units including at least a structural unit A, a structural unit B, and a structural unit C. The structural unit A is derived from an alkyl methacrylate whose homopolymerized polymer has a glass transition point of −50° C. to 0° C., the structural unit B is derived from an alkyl acrylate whose homopolymerized polymer has a glass transition point of −70° C. to −50° C., and the structural unit C is derived from a polyfunctional vinyl monomer.

It is possible that the microparticles have an average particle size of 10 to 100 nm.

It is possible that the content ratio of the structural unit B in the microparticles is 10 to 80 mass %.

It is possible that the structural unit B is derived from n-butyl acrylate.

A pneumatic tire according to an aspect of the invention is made using the above rubber composition.

The rubber composition according to an aspect of the invention makes it possible to obtain a pneumatic tire with an excellent balance between rolling resistance performance (fuel efficiency) and wet grip performance.

### DESCRIPTION OF THE PREFERRED EMBODIMENTS

Hereinafter, matters relevant to the implementation of the invention will be described in detail.

The rubber composition according to this embodiment contains, per 100 parts by mass of a diene-based rubber, 1 to 100 parts by mass of microparticles formed of a polymer having a glass transition point of −70° C. to 0° C., and the polymer includes a random copolymer composed of three or more kinds of structural units including at least a structural unit A, a structural unit B, and a structural unit C. The structural unit A is derived from an alkyl methacrylate whose homopolymerized polymer has a glass transition point of −50° C. to 0° C., the structural unit B is derived from an alkyl acrylate whose homopolymerized polymer has a glass transition point of −70° C. to −50° C., and the structural unit C is derived from a polyfunctional vinyl monomer.

As the diene-based rubber, for example, natural rubber (NR), synthetic isoprene rubber (IR), butadiene rubber (BR), styrene butadiene rubber (SBR), nitrile rubber (NBR), chloroprene rubber (CR), butyl rubber (IIR), styrene-isoprene copolymer rubbers, butadiene-isoprene copolymer rubbers, styrene-isoprene-butadiene copolymer rubbers, and the like can be mentioned. They may be used alone, and it is also possible to use a combination of two or more kinds. Among them, it is preferable to use at least one kind selected from the group consisting of NR, BR, and SBR.

Specific examples of the diene-based rubbers listed above also include a modified diene-based rubber having at least one functional group selected from the group consisting of a hydroxyl group, an amino group, a carboxyl group, an alkoxy group, an alkoxysilyl group, and an epoxy group introduced into its molecular end or molecular chain, and thus modified with such a functional group. As modified diene-based rubbers, modified SBR and/or modified BR is preferable. In one embodiment, the diene-based rubber may be a modified diene-based rubber alone, or may also be a blend of a modified diene-based rubber and an unmodified diene-based rubber. In one embodiment, in 100 parts by mass of a diene-based rubber, 30 parts by mass or more of modified SBR may be contained, or 50 to 90 parts by mass of modified SBR and 50 to 10 parts by mass of unmodified diene-based rubber (e.g., BR and/or NR) may also be contained.

The glass transition point (Tg) of the microparticle-forming random copolymer according to this embodiment is not particularly limited as long as it is within a range of −70° C. to 0° C., but is preferably −60° C. to −20° C., and more preferably −55° C. to −30° C. The glass transition point can be set by the monomer composition of a (meth)acrylate-based polymer or the like. When the glass transition point is 0° C. or less, it is easier to suppress deterioration of low-temperature performance more effectively. In addition, when the glass transition point is −70° C. or more, it is easier to enhance the improving effect on wet grip performance. Here, the glass transition point (Tg) is a value measured by a differential scanning calorimetry (DSC) method in accordance with JIS K7121 at a temperature rise rate of 20° C./min (measurement temperature range: −150° C. to 150° C.).

The structural unit A and the structural unit B of the microparticle-forming random copolymer can both be represented by the following general formula (1).

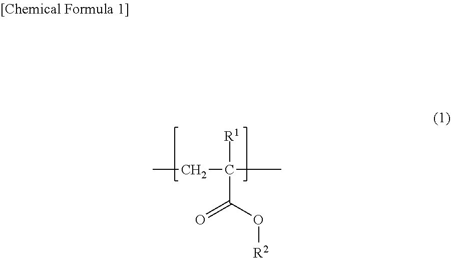

In the case of the structural unit A, in the formula, R¹ is a methyl group, R² is a C₅₋₁₅ alkyl group, and R²s in the same molecule may be the same or different. The alkyl group of R² may be linear or branched. R² is preferably a CE-14 alkyl group, and more preferably a C₈₋₁₂ alkyl group.

As monomers to form the structural unit A, for example, n-alkyl methacrylates such as n-pentyl methacrylate, n-hexyl methacrylate, n-heptyl methacrylate, n-octyl methacrylate, and n-nonyl methacrylate; isoalkyl methacrylates such as isohexyl methacrylate, isoheptyl methacrylate, isooctyl methacrylate, isononyl methacrylate, isodecyl methacrylate, isoundecyl methacrylate, isododecyl methacrylate, isotridecyl methacrylate, and isotetradecyl methacrylate; 2-methylpentyl methacrylate, 2-methylhexyl methacrylate, 2-ethylhexyl methacrylate, 2-ethylheptyl methacrylate, and the like can be mentioned. They can be used alone, and it is also possible to use a combination of two or more kinds.

Here, an isoalkyl refers to an alkyl group having a methyl side chain on the second carbon atom from the alkyl chain end. For example, isodecyl refers to a C₁₀ alkyl group having a methyl side chain on the second carbon atom from the chain end, and this concept includes not only an 8-methylnonyl group but also a 2,4,6-trimethylheptyl group.

In the case of the structural unit B, in the formula, R¹ is hydrogen, R² is a C₄₋₁₀ alkyl group, and R²s in the same molecule may be the same or different. The alkyl group of R² may be linear or branched. R² is preferably a C₄₋₉ alkyl group, and more preferably a C₄₋₈ alkyl group.

As monomers to form the structural unit B, for example, n-alkyl acrylates such as n-butyl acrylate, n-pentyl acrylate, n-hexyl acrylate, n-heptyl acrylate, n-octyl acrylate, n-nonyl acrylate, and n-decyl acrylate; isoalkyl acrylates such as isobutyl acrylate, isopentyl acrylate, isohexyl acrylate, isoheptyl acrylate, isooctyl acrylate, isononyl acrylate, and isodecyl acrylate; 2-methylbutyl acrylate, 2-ethylpentyl acrylate, 2-methylhexyl acrylate, 2-ethylhexyl acrylate, 2-ethylheptyl acrylate, and the like can be mentioned. Among them, n-butyl acrylate is preferable. They can be used alone, and it is also possible to use a combination of two or more kinds.

The microparticle-forming random copolymer according to this embodiment is crosslinked, and the structural unit C is a structural unit derived from a polyfunctional vinyl monomer that serves as its crosslinking point. That is, in a preferred embodiment, the random copolymer contains, together with the structural units represented by formula (1), the structural unit C derived from a polyfunctional vinyl monomer, and has a crosslinked structure in which the polyfunctional vinyl monomer-derived structural unit serves as the crosslinking point.

As the polyfunctional vinyl monomer, a free radically polymerizable compound having at least two vinyl groups can be mentioned. For example, vinyl aromatic compounds having at least two vinyl groups, such as di(meth)acrylates or tri(meth)acrylates of diols or triols (e.g., ethylene glycol, propylene glycol, 1,4-butanediol, 1,6-hexanediol, 1,12-dodecanediol, trimethylolpropane, etc.); alkylene di(meth)acrylamides such as methylene bis-acrylamide; diisopropenylbenzene, divinylbenzene, trivinylbenzene, and the like can be mentioned. They can be used alone, and it is also possible to use a combination of two or more kinds.

In all structural units (all repeating units) of the microparticle-forming random copolymer, the content ratio of the structural unit A is preferably 20 to 90 mass %, and more preferably 40 to 90 mass %. The content ratio of the structural unit B is preferably 10 to 80 mass %, and more preferably 10 to 60 mass %. The content ratio of the structural unit C is preferably 0.1 to 10 mass %, and more preferably 1 to 5 mass %. Incidentally, the random copolymer may also contain other structural units in addition to the structural units A, B, and C to the extent they are not inconsistent with the objectives of the invention.

The rubber composition according to this embodiment contains the above microparticles and, as a result, provides excellent rolling resistance performance (fuel efficiency) and wet grip performance. This mechanism is not clear, but can be presumed as follows. In the microparticle structure, as a result of containing a structural unit A which is derived from an alkyl methacrylate whose polymer, when homopolymerized, has a Tg of −50° C. to 0° C., the loss coefficient tan S in the low temperature range increases, and the wet grip performance improves, while as a result of containing a structural unit B which is derived from an alkyl acrylate whose polymer, when homopolymerized, has a Tg of −70° C. to −50° C., the loss coefficient tan S in the high temperature range decreases, and the rolling resistance performance improves.

The average particle size of the microparticles according to this embodiment is not particularly limited, but is preferably 10 nm to 100 nm, and more preferably 20 nm to 60 nm. Here, as used herein, the average particle size of microparticles is the average particle size of polymer particles dispersed in the latex (latex particle size (M_{L})), and is a value determined by a cumulant method. Specifically, it is the particle size at an integrated value of 50% (50% diameter: D50) in the particle size distribution measured by dynamic light scattering (DLS), and is a value determined by a cumulant method from an autocorrelation function obtained from measurement by the photon correlation method (in accordance with JIS Z8826) (angle between the incident light and the detector: 90°).

The method for producing the microparticles according to this embodiment is not particularly limited, and, for example, known emulsion polymerization can be utilized for their synthesis. A preferred example is as follows. That is, a structural unit A-forming monomer and a structural unit B-forming monomer are dispersed together with a structural unit C-forming monomer in an aqueous medium such as water having dissolved therein an emulsifier, and, to the obtained emulsion, a water-soluble radical polymerization initiator (e.g., peroxide such as potassium persulfate) is added to cause radical polymerization. As a result, polymer microparticles formed of an alkyl (meth)acrylate-based polymer are generated in the aqueous medium. As other methods for producing polymer particles, known polymerization methods such as suspension polymerization, dispersion polymerization, precipitation polymerization, mini-emulsion polymerization, soap-free emulsion polymerization (emulsifier-free emulsion polymerization), and micro-emulsion polymerization can be utilized.

In the rubber composition according to this embodiment, the amount of the microparticles blended is 1 to 100 parts by mass, preferably 2 to 50 parts by mass, and more preferably 3 to 30 parts by mass, per 100 parts by mass of the diene-based rubber.

In the rubber composition according to this embodiment, in addition to the above microparticles, it is also possible to blend various additives commonly used in rubber compositions, such as reinforcing fillers, silane coupling agents, oils, zinc oxide, stearic acid, antioxidants, waxes, vulcanizing agents, and vulcanization accelerators.

As reinforcing fillers, for example, silica such as wet silica (hydrous silicic acid) and carbon black are used. Preferably, in order to improve the balance between rolling resistance performance and wet grip performance, use of silica alone or combined use of silica and carbon black is preferable. The amount of reinforcing filler blended is not particularly limited, and may be, for example, 20 to 150 parts by mass, or 30 to 100 parts by mass, per 100 parts by mass of the rubber component. The amount of silica blended is not particularly limited either, and may be, for example, 20 to 150 parts by mass, or 30 to 100 parts by mass, per 100 parts by mass of the rubber component.

In the case where silica is blended, it is preferable to use a silane coupling agent together. In that case, the amount of silane coupling agent blended is preferably 2 to 20 mass %, more preferably 4 to 15 mass %, of the silica mass.

A preferred example of the vulcanizing agents is sulfur. The amount of vulcanizing agent blended is not particularly limited, but is preferably 0.1 to 10 parts by mass, more preferably 0.5 to 5 parts by mass, per 100 parts by mass of the rubber component. In addition, as the vulcanization accelerators, for example, sulfenamide-based, thiuram-based, thiazole-based, guanidine-based, and like various vulcanization accelerators can be mentioned. They may be used alone, and it is also possible to use a combination of two or more kinds. The amount of vulcanization accelerator blended is not particularly limited, but is preferably 0.1 to 7 parts by mass, more preferably 0.5 to 5 parts by mass, per 100 parts by mass of the rubber component.

The rubber composition according to this embodiment can be made by kneading in the usual manner using a mixer that is usually used, such as a Banbury mixer, a kneader, or a roll. That is, for example, in the first mixing stage, the above microparticles and other additives excluding a vulcanizing agent and a vulcanization accelerator are added to a diene-based rubber and mixed, and subsequently, in the final mixing stage, the vulcanizing agent and the vulcanization accelerator are added to the obtained mixture and mixed, whereby the rubber composition can be prepared.

The rubber composition thus obtained is applicable to various tire parts, such as the tread and side wall of pneumatic tires of various sizes for various applications, including tires for passenger cars, large-sized tires for trucks and buses, and the like. That is, the rubber composition is formed into a predetermined shape in the usual manner, for example by extrusion, and combined with other parts to make a green tire, and then the green tire is vulcanization-molded at 140 to 180° C., for example, whereby a pneumatic tire can be produced. Among them, use as a formulation for the tread of a tire is particularly preferable.

### EXAMPLES

Hereinafter, examples of the invention will be shown, but the invention is not limited to these examples.

### [Method for Measuring Average Particle Size]

The average particle size of microparticles is the particle size at an integrated value of 50% (50% diameter: D50) in the particle size distribution measured by dynamic light scattering (DLS). Using a latex solution before coagulation in the following synthesis examples as a measurement sample, the average particle size was measured by the photon correlation method (in accordance with JIS Z8826) using a dynamic light scattering photometer “DLS-8000” manufactured by Otsuka Electronics Co., Ltd.) (angle between the incident light and the detector: 90°).

### [Method for Measuring Tg]

Tg was measured by a differential scanning calorimetry (DSC) method in accordance with JIS K7121 at a temperature rise rate of 20° C./min (measurement temperature range: −150° C. to 150° C.).

### [Synthesis Example A: Polymer A] Homopolymer of Alkyl Methacrylate of −50° C. to 0° C.

40.0 g of 2,4,6-trimethylheptyl methacrylate (isodecyl methacrylate), 2.04 g of sodium dodecyl sulfate, and 100.0 g of water were mixed and stirred for 1 hour to emulsify the monomers, and 0.48 g of potassium persulfate was added. After the addition, nitrogen bubbling was performed for 20 minutes, and the solution was stirred at 70° C. for 3 hours to give a latex solution. The latex solution was poured into stirring methanol to precipitate a polymer. Subsequently, the liquid was removed by filtration, followed by drying in a vacuum dryer under conditions of 70° C. and 1.0×10³ Pa, thereby giving poly(isodecyl methacrylate) as a solid component. The Tg of poly(isodecyl methacrylate) was −40° C.

### [Synthesis Example B: Polymer B] Homopolymer of Alkyl Acrylate of −70° C. to −50° C.

40.0 g of n-butyl acrylate, 2.04 g of sodium dodecyl sulfate, and 100.0 g of water were mixed and stirred for 1 hour to emulsify the monomers, and 0.48 g of potassium persulfate was added. After the addition, nitrogen bubbling was performed for 20 minutes, and the solution was stirred at 70° C. for 3 hours to give a latex solution. The latex solution was poured into stirring methanol to precipitate a polymer. Subsequently, the liquid was removed by filtration, followed by drying in a vacuum dryer under conditions of 70° C. and 1.0×10³ Pa, thereby giving poly(n-butyl acrylate) as a solid component. The Tg of poly(n-butyl acrylate) was −53° C.

### [Synthesis Example C: Polymer C] Homopolymer of Alkyl Methacrylate of −70° C. to −50° C.

40.0 g of dodecyl methacrylate, 2.04 g of sodium dodecyl sulfate, and 100.0 g of water were mixed and stirred for 1 hour to emulsify the monomers, and 0.48 g of potassium persulfate was added. After the addition, nitrogen bubbling was performed for 20 minutes, and the solution was stirred at 70° C. for 3 hours to give a latex solution. The latex solution was poured into stirring methanol to precipitate a polymer. Subsequently, the liquid was removed by filtration, followed by drying in a vacuum dryer under conditions of 70° C. and 1.0×10³ Pa, thereby giving poly(dodecyl methacrylate) as a solid component. The Tg of poly(dodecyl methacrylate) was −64° C.

### Synthesis Example 1: Synthesis of Microparticles 1

(Microparticles of Alkyl Methacrylate with Homopolymer Tg of −50° C. to 0° C. and Polyfunctional Vinyl Monomer)

40.0 g of 2,4,6-trimethylheptyl methacrylate (isodecyl methacrylate), 1.63 g of 1,12-dodecanediol dimethacrylate, 2.04 g of sodium dodecyl sulfate, and 100.0 g of water were mixed and stirred for 1 hour to emulsify the monomers, and 0.48 g of potassium persulfate was added. After the addition, nitrogen bubbling was performed for 20 minutes, and the solution was stirred at 70° C. for 3 hours to give a latex solution. The latex solution was poured into stirring methanol to precipitate microparticles. Subsequently, the liquid was removed by filtration, followed by drying in a vacuum dryer under conditions of 70° C. and 1.0×10³ Pa, thereby giving microparticles 1 as a solid component. The microparticles 1 had an average particle size of 45 nm and a Tg of −37° C.

### Synthesis Example 2: Synthesis of Microparticles 2

(Microparticles of Alkyl Acrylate with Homopolymer Tg of −70° C. to −50° C. and Polyfunctional Vinyl Monomer)

40.0 g of n-butyl acrylate, 1.63 g of 1,12-dodecanediol dimethacrylate, 2.04 g of sodium dodecyl sulfate, and 100.0 g of water were mixed and stirred for 1 hour to emulsify the monomers, and 0.48 g of potassium persulfate was added. After the addition, nitrogen bubbling was performed for 20 minutes, and the solution was stirred at 70° C. for 3 hours to give a latex solution. The latex solution was poured into stirring methanol to precipitate microparticles. Subsequently, the liquid was removed by filtration, followed by drying in a vacuum dryer under conditions of 70° C. and 1.0×10³ Pa, thereby giving microparticles 2 as a solid component. The microparticles 2 had an average particle size of 60 nm and a Tg of −51° C.

### Synthesis Example 3: Synthesis of Microparticles 3

(Microparticles of Random Copolymer of Alkyl Methacrylate with Homopolymer Tg of −50° C. to 0° C., Alkyl Acrylate with Homopolymer Tg of −70° C. to −50° C., and Polyfunctional Vinyl Monomer)

32.0 g of 2,4,6-trimethylheptyl methacrylate (isodecyl methacrylate), 8.0 g of n-butyl acrylate, 1.63 g of 1,12-dodecanediol dimethacrylate, 2.04 g of sodium dodecyl sulfate, and 100.0 g of water were mixed and stirred for 1 hour to emulsify the monomers, and 0.48 g of potassium persulfate was added. After the addition, nitrogen bubbling was performed for 20 minutes, and the solution was stirred at 70° C. for 3 hours to give a latex solution. The latex solution was poured into stirring methanol to precipitate microparticles. Subsequently, the liquid was removed by filtration, followed by drying in a vacuum dryer under conditions of 70° C. and 1.0×10³ Pa, thereby giving microparticles 3 as a solid component. The microparticles 3 had an average particle size of 43 nm and a Tg of −42° C.

### Synthesis Example 4: Synthesis of Microparticles 4

(Microparticles of Random Copolymer of Alkyl Methacrylate with Homopolymer Tg of −50° C. to 0° C., Alkyl Acrylate with Homopolymer Tg of −70° C. to −50° C., and Polyfunctional Vinyl Monomer)

24.0 g of 2,4,6-trimethylheptyl methacrylate (isodecyl methacrylate), 16.0 g of n-butyl acrylate, 1.63 g of 1,12-dodecanediol dimethacrylate, 2.04 g of sodium dodecyl sulfate, and 100.0 g of water were mixed and stirred for 1 hour to emulsify the monomers, and 0.48 g of potassium persulfate was added. After the addition, nitrogen bubbling was performed for 20 minutes, and the solution was stirred at 70° C. for 3 hours to give a latex solution. The latex solution was poured into stirring methanol to precipitate microparticles. Subsequently, the liquid was removed by filtration, followed by drying in a vacuum dryer under conditions of 70° C. and 1.0×10³ Pa, thereby giving microparticles 4 as a solid component. The microparticles 4 had an average particle size of 44 nm and a Tg of −45° C.

### Synthesis Example 5: Synthesis of Microparticles 5

(Microparticles of Random Copolymer of Alkyl Methacrylate with Homopolymer Tg of −50° C. to 0° C., Alkyl Acrylate with Homopolymer Tg of −70° C. to −50° C., and Polyfunctional Vinyl Monomer)

16.0 g of 2,4,6-trimethylheptyl methacrylate (isodecyl methacrylate), 24.0 g of n-butyl acrylate, 1.63 g of polyethylene glycol #200 diacrylate, 2.04 g of sodium dodecyl sulfate, and 100.0 g of water were mixed and stirred for 1 hour to emulsify the monomers, and 0.48 g of potassium persulfate was added. After the addition, nitrogen bubbling was performed for 20 minutes, and the solution was stirred at 70° C. for 3 hours to give a latex solution. The latex solution was poured into stirring methanol to precipitate microparticles. Subsequently, the liquid was removed by filtration, followed by drying in a vacuum dryer under conditions of 70° C. and 1.0×10³ Pa, thereby giving microparticles 5 as a solid component. The microparticles 5 had an average particle size of 44 nm and a Tg of −49° C.

### Synthesis Example 6: Synthesis of Microparticles 6

(Microparticles of Random Copolymer of Alkyl Methacrylate with Homopolymer Tg of −50° C. to 0° C., Alkyl Acrylate with Homopolymer Tg of −70° C. to −50° C., and Polyfunctional Vinyl Monomer)

8.0 g of 2,4,6-trimethylheptyl methacrylate (isodecyl methacrylate), 32.0 g of n-butyl acrylate, 1.63 g of 1,12-dodecanediol dimethacrylate, 2.04 g of sodium dodecyl sulfate, and 100.0 g of water were mixed and stirred for 1 hour to emulsify the monomers, and 0.48 g of potassium persulfate was added. After the addition, nitrogen bubbling was performed for 20 minutes, and the solution was stirred at 70° C. for 3 hours to give a latex solution. The latex solution was poured into stirring methanol to precipitate microparticles. Subsequently, the liquid was removed by filtration, followed by drying in a vacuum dryer under conditions of 70° C. and 1.0×10³ Pa, thereby giving microparticles 6 as a solid component. The microparticles 6 had an average particle size of 49 nm and a Tg of −51° C.

### Synthesis Example 7: Synthesis of Microparticles 7

(Microparticles of Block Copolymer of Alkyl Methacrylate with Homopolymer Tg of −50° C. to 0° C., Alkyl Acrylate with Homopolymer Tg of −70° C. to −50° C., and Polyfunctional Vinyl Monomer)

20.0 g of 2,4,6-trimethylheptyl methacrylate (isodecyl methacrylate), 1.63 g of 1,12-dodecanediol dimethacrylate, 2.04 g of sodium dodecyl sulfate, and 90.0 g of water were mixed and stirred for 1 hour to emulsify the monomers, and 0.48 g of potassium persulfate was added. After the addition, nitrogen bubbling was performed for 20 minutes, and the solution was stirred at 70° C. for 2 hours. Next, 20.0 g of butyl acrylate was added to the above solution and stirred for 3 hours to give a latex solution. The latex solution was poured into stirring methanol to precipitate microparticles. Subsequently, the liquid was removed by filtration, followed by drying in a vacuum dryer under conditions of 70° C. and 1.0×10 Pa, thereby giving microparticles 7 as a solid component. The microparticles 7 had an average particle size of 52 nm and a Tg of −45° C.

### Synthesis Example 8: Synthesis of Microparticles 8

(Microparticles of Random Copolymer of Alkyl Methacrylate with Homopolymer Tg of −50° C. to 0° C., Alkyl Methacrylate with Homopolymer Tg of −70° C. to −50° C., and Polyfunctional Vinyl Monomer)

20.0 g of 2,4,6-trimethylheptyl methacrylate (isodecyl methacrylate), 20.0 g of dodecyl methacrylate, 1.63 g of 1,12-dodecanediol dimethacrylate, 2.04 g of sodium dodecyl sulfate, and 90.0 g of water were mixed and stirred for 1 hour to emulsify the monomers, and 0.48 g of potassium persulfate was added. After the addition, nitrogen bubbling was performed for 20 minutes, and the solution was stirred at 70° C. for 3 hours to give a latex solution. The latex solution was poured into stirring methanol to precipitate microparticles. Subsequently, the liquid was removed by filtration, followed by drying in a vacuum dryer under conditions of 70° C. and 1.0×10 Pa, thereby giving microparticles 8 as a solid component. The microparticles 8 had an average particle size of 70 nm and a Tg of −50° C.

Using a lab mixer, according to the formulation (parts by mass) shown below in Table 1, first, in the first mixing stage, blend ingredients excluding sulfur and a vulcanization accelerator were added to a diene-based rubber component and kneaded (discharge temperature: 160° C.). Next, in the final mixing stage, sulfur and the vulcanization accelerator were added to the obtained kneaded product and kneaded (discharge temperature: 90° C.), thereby preparing a rubber composition. The details of the components in Table 1 are as follows.
Modified SBR: “HPR350” manufactured by JSR Corporation
BR: “BR150B” manufactured by Ube Industries, Ltd.
Silica: “Nipsil AQ” manufactured by Tosoh Silica Corporation
Silane coupling agent: Bis(3-triethoxysilylpropyl) tetrasulfide, “Si69” manufactured by Evonik Japan Co., Ltd.
Microparticles 1 to 8: Microparticles obtained above in Synthesis Examples 1 to 8, respectively
Zinc oxide: “Zinc Oxide No. 1” manufactured by Mitsui Mining & Smelting Co., Ltd.
Antioxidant: “Nocrac 6C” manufactured by Ouchi Shinko Chemical Industrial Co., Ltd.
Stearic acid: “LUNAC S-20” manufactured by Kao Corporation
Sulfur: “Powder Sulfur for Rubber, 150 mesh” manufactured by Hosoi Chemical Industry Co., Ltd.
Vulcanization accelerator: “Nocceler CZ” manufactured by Ouchi Shinko Chemical Industrial Co., Ltd.
Secondary vulcanization accelerator: “Nocceler D” manufactured by Ouchi Shinko Chemical Industrial Co., Ltd.

Each obtained rubber composition was vulcanized at 160° C. for 20 minutes to give a specimen having a predetermined shape, and, using the obtained specimen, a dynamic viscoelasticity test was performed to measure tan S at 0° C. and 60° C. The measurement method is as follows.
0° C. Tan δ: Using a LEO spectrometer E4000 manufactured by UBM, the loss coefficient tan δ was measured under the following conditions: frequency: 10 Hz, static strain: 10%, dynamic strain: 2%, temperature: 0° C. The result was expressed as an index taking the value of Comparative Example 1 as 100. The larger the index, the larger the tan δ, indicating that the wet grip performance is excellent.
60° C. Tan S: Tan S measurement was performed in the same manner as for 0° C. tan δ, except that the temperature was changed to 60° C. The result was expressed as an index taking the value of Comparative Example 1 as 100. The smaller the index is, the less likely it is that heat will be generated, indicating that the tire has low rolling resistance, and the rolling resistance performance (i.e., fuel efficiency) is excellent.

TABLE 1

| | Comparative | Comparative | | | | | Comparative | Comparative |
|---|---|---|---|---|---|---|---|---|
| | Example 1 | Example 2 | Example 1 | Example 2 | Example 3 | Example 4 | Example 3 | Example 4 |
| Modified SBR | 60 | 60 | 60 | 60 | 60 | 60 | 60 | 60 |
| BR | 40 | 40 | 40 | 40 | 40 | 40 | 40 | 40 |
| Silica | 70 | 70 | 70 | 70 | 70 | 70 | 70 | 70 |
| Silane coupling agent | 5.6 | 5.6 | 5.6 | 5.6 | 5.6 | 5.6 | 5.6 | 5.6 |
| Microparticles 1 | 20 | — | — | — | — | — | — | — |
| Microparticles 2 | — | 20 | — | — | — | — | — | — |
| Microparticles 3 | — | — | 20 | — | — | — | — | — |
| Microparticles 4 | — | — | — | 20 | — | — | — | — |
| Microparticles 5 | — | — | — | — | 20 | — | — | — |
| Microparticles 6 | — | — | — | — | — | 20 | — | — |
| Microparticles 7 | — | — | — | — | — | — | 20 | — |
| Microparticles 8 | — | — | — | — | — | — | — | 20 |
| Zinc oxide | 2 | 2 | 2 | 2 | 2 | 2 | 2 | 2 |
| Antioxidant | 2 | 2 | 2 | 2 | 2 | 2 | 2 | 2 |
| Stearic acid | 2 | 2 | 2 | 2 | 2 | 2 | 2 | 2 |
| Sulfur | 1.8 | 1.8 | 1.8 | 1.8 | 1.8 | 1.8 | 1.8 | 1.8 |
| Vulcanization accelerator | 1.8 | 1.8 | 1.8 | 1.8 | 1.8 | 1.8 | 1.8 | 1.8 |
| Secondary vulcanization accelerator | 1.5 | 1.5 | 1.5 | 1.5 | 1.5 | 1.5 | 1.5 | 1.5 |
| 0° C. Tan δ | 100 | 84 | 110 | 109 | 105 | 101 | 97 | 94 |
| 60° C. Tan δ | 100 | 93 | 96 | 90 | 91 | 94 | 98 | 97 |

The results are as shown in Table 1. In Examples 1 to 4 where microparticles formed of a random copolymer of the structural unit A, the structural unit B, and the structural unit C were blended, the balance between rolling resistance performance (fuel efficiency) and wet grip performance was excellent.

Comparative Example 1 is an example where microparticles composed of a random copolymer of the structural unit A and the structural unit C were blended. As compared with Examples 1 to 4, the rolling resistance performance and wet grip performance were inferior.

Comparative Example 2 is an example where microparticles composed of a random copolymer of the structural unit B and the structural unit C were blended. As compared with Examples 1 to 4, the wet grip performance was inferior.

Comparative Example 3 is an example where microparticles composed of a block copolymer of the structural unit A, the structural unit B, and the structural unit C were blended. As compared with Examples 1 to 4, the rolling resistance performance and wet grip performance were inferior.

Comparative Example 4 is an example where microparticles composed of a random copolymer containing, in place of the structural unit B, a structural unit derived from an alkyl methacrylate having a glass transition point outside the predetermined range were blended. As compared with Examples 1 to 4, the rolling resistance performance and wet grip performance were inferior.

### INDUSTRIAL APPLICABILITY

The rubber composition of the invention can be used as a rubber composition for various tires for passenger cars, light trucks, buses, and the like.

What is claimed is:

1. A rubber composition comprising, per 100 parts by mass of a diene-based rubber, 1 to 100 parts by mass of microparticles formed of a polymer having a glass transition point of −70° C. to 0° C.,
the polymer including a random copolymer composed of three or more kinds of structural units including at least a structural unit A, a structural unit B, and a structural unit C,
the structural unit A being derived from an alkyl methacrylate whose homopolymerized polymer has a glass transition point of −50° C. to 0° C.,
the structural unit B being derived from an alkyl acrylate whose homopolymerized polymer has a glass transition point of −70° C. to −50° C.,
the structural unit C being derived from a polyfunctional vinyl monomer.

2. The rubber composition according to claim 1, wherein the microparticles have an average particle size of 10 to 100 nm.

3. The rubber composition according to claim 1, wherein the content ratio of the structural unit B in the microparticles is 10 to 80 mass %.

4. The rubber composition according to claim 2, wherein the content ratio of the structural unit B in the microparticles is 10 to 80 mass %.

5. The rubber composition according to claim 1, wherein the structural unit B is derived from n-butyl acrylate.

6. The rubber composition according to claim 2, wherein the structural unit B is derived from n-butyl acrylate.

7. The rubber composition according to claim 3, wherein the structural unit B is derived from n-butyl acrylate.

8. The rubber composition according to claim 4, wherein the structural unit B is derived from n-butyl acrylate.

9. A pneumatic tire made using the rubber composition according to claim 1.

10. A pneumatic tire made using the rubber composition according to claim 2.

11. A pneumatic tire made using the rubber composition according to claim 3.

12. A pneumatic tire made using the rubber composition according to claim 4.

13. A pneumatic tire made using the rubber composition according to claim 5.

14. A pneumatic tire made using the rubber composition according to claim 6.

15. A pneumatic tire made using the rubber composition according to claim 7.

16. A pneumatic tire made using the rubber composition according to claim 8.
